(19) United States
(12) Patent Application Publication
(10) Pub. No.: US 2004/0156211 A1
(43) Pub. Date: Aug. 12, 2004

(54) Automobile headlight device fitted with electroluminescent diodes

(76) Inventor: Eric Blusseau, Bobigny (FR)

Correspondence Address: MORGAN & FINNEGAN, L.L.P., 345 PARK AVENUE, NEW YORK, NY, 10154, US

(21) Appl. No.: 10/771,681

(22) Filed: Feb. 3, 2004

(30) Foreign Application Priority Data
Feb. 7, 2003 (FR) 0301511

(51) Int. Cl. F21S 8/10

(52) U.S. Cl. 362/545

(57) ABSTRACT

The object of the invention is a headlight device, the intention of which is to emit at least one type of luminous beam, comprising at least one luminous source and at least one reflecting surface, to reflect luminous rays produced by the luminous source, the luminous source, or at least one of the luminous sources, comprising at least one element of the electroluminescent diode type.

### FIELD OF THE INVENTION

The subject of the present invention is an automobile headlight device fitted with electroluminescent diodes. The essential purpose of the invention is to offer an alternative solution to headlight devices which use luminous light sources of the halogen type or of the discharge-lamp type, which pose quite a number of problems with regard to making headlight devices.

### BACKGROUND OF THE INVENTION

The area of application of the invention is, taken in a general sense, that of automobile vehicle headlights. In this area, different types of headlight are known, the chief of which are:

Side-lights, of low intensity and short range

Dipped-beam lights, of greater intensity, designed to illuminate the road up to approximately 70 metres ahead, which are chiefly used at night and have a luminous beam in respect of which the area it illuminates is such as to avoid dazzling the drivers of oncoming vehicles;

Long-range headlights, and additional long-range lights, the range of which is approximately 200 metres, and which must be switched off when another vehicle is approaching, in order to avoid dazzling its driver;

Improved headlights, known as dual-mode lights, which combine the functions of dipped-beam lights and of full-beam lights, and include a removable obscuring means

Fog-lights

Furthermore, in addition to these classic headlights, various improvements have progressively appeared. Thus one has seen the development of more elaborate functions, referred to as advanced functions, notable among them being the following:

A function referred to as DBL (Dynamic Bending Light): this function allows a luminous beam produced by a luminous source to be directed, for example by moving a reflector in relation to the source of light with which it is associated, such that, when the vehicle is approaching a bend, the road is illuminated to the optimum degree;

A function referred to as FBL (Fixed Bending Light): the purpose of this function is to illuminate the verge of the road progressively when the vehicle is being driven round a bend; to this end, a supplementary luminous source is provided, which progressively complements the dipped and main-beam headlight functions when a bend is being negotiated;

A function referred to as DRL (Day Running Light): this function, currently called daytime traffic-mode light, ensures that the headlight device keeps the lights in a permanent “on” setting, notably to make pedestrians aware of the presence of the vehicle among the traffic, and thus to avoid running into pedestrians.

A function referred to as Town Light in English: this function ensures the spreading out of a dipped headlight beam at the same time slightly lessening its range;

A function referred to as Motorway Light. This function ensures an increase in the range of a dipped headlight.

A function referred to as AWL (Adverse Weather Light):

this function ensures a modification of a dipped headlight beam such that the driver is not dazzled by a reflection from his own headlight;

A function referred to as Overhead Light. This function ensures a modification of a dipped headlight beam such that traffic signals situated well above ground level are illuminated in a satisfactory manner by means of dipped headlights.

The functions DBL, FBL, AWL, Town Light, Motorway Light and Overhead Light are collectively known as AFS functions. The headlight device in accordance with the invention will essentially be described in an application which refers to dipped headlights. Nevertheless, it could be used in any other headlight device referred to, or could be a contributing element in one of three functions mentioned. The description of the invention in the terms of reference of dipped headlights in no way restricts to this single application.

What is more, two principal groups of headlamps exist which correspond to two distinct arrangements of the component parts of the headlight.

The first group is that of headlights referred to as elliptic. In this type of headlight a concentrated luminous patch of light originates from a luminous source. Typically the luminous source is set up at the first focal point of a mirror in an ellipsoidal shape, the aforementioned patch forming at the second focal point of the mirror. The concentrated patch of luminous light is then shone onto the road by a convergent lens for example a lens of the planoconvex type.

The second group is that of headlights referred to as complex surface reflection headlights, or parabolic headlights. In this type of headlight a luminous beam originates in a small luminous source set up in a reflector or mirror. The shining onto the road of luminous rays, reflected by a reflector of an appropriate kind, allows the direct production of a luminous beam which complies with the various demands imposed by the standards. This group of headlights includes headlights referred to as free surface or complex surface headlights which allow the direct production of a luminous beam, giving a desired cut-off line of illumination. The device which accords with the invention, relates to this group of headlights in particular.

A parabolic headlight device exemplifying the current state of the art, for example of the dipped headlight type, is schematically represented by a sectional view in FIG. 1. A dipped-mode light 100 essentially comprises, in the classic manner, inside a casing 105, a reflector 101, a source of light 102, giving out luminous rays 103, set up near the focal point of the reflector 101 and an exit surface 104, through which the luminous beam 106 is shone. The term “luminous beam” is defined as the totality of luminous rays which are effectively emitted by a headlight at the level of the exit surface, the volume illuminated by the luminous beam corresponding to the field of vision of the driver; by luminous rays is meant the totality of the luminous signals emitted by the source of light 102. In the current state of the art, as in the device which accords with the invention, the luminous rays 103 are emitted either directly towards the exit surface 104, or indirectly after having undergone possible deviations and/or reflections.

FIG. 2 shows the reflector 101 viewed from the front. The reflector 101 is subdivided virtually into several distinct areas, each of the areas making a rigorously defined contribution to the composition of the luminous beam 106 emitted by the headlight. A projection 300, onto a single plane, of this luminous beam, is shown in FIG. 3. In the case of a dipped headlight, the luminous projection 300, is horizontally limited by a cut-off line 306.

The luminous projection 300 is artificially subdivided into distinct zones. A first zone 301 and a second zone 302 make up the zones referred to as the range of the luminous beam. It is in these zones that the intensity of the beam must be at its greatest. It must allow an acceptable visibility of 70 metres to be achieved on the main highway. A third zone 303 and a fourth zone 304 make up those referred to as comfort zones. They allow an acceptable visibility of about 40 metres to be achieved. A fifth zone 305 makes up that referred to as the breadth zone. It allows a downward visibility to be achieved, that is to say illuminating the asphalt, acceptable at about 30 metres.

The luminous source 102 of the headlight device contributes to each of the zones which have just been referred to by reflecting against the reflector 101 in a different way as relates to the areas of reflection in which the image of the luminous source is formed. Thus one can regard the first range zone 301 and the second range zone 302 of the luminous beam as essentially constituted of images from the luminous source respectively being reflected in a first area 201 and in a second area 202 of the reflecting surface of the headlight 101. These two areas are approximately horizontal, that is to say, set up near a central and horizontal orientation of the headlight device; effectively, the images from the luminous source 102 in these areas must be more or less horizontal to be aligned exactly under the cut off line 306 of the luminous projection 300, and, taking into account the broadly cylindrical nature of luminous sources of the halogen type lamp or the discharge type lamp, the length, set up in accordance with the axis of projection of the headlight, being clearly less than the breadth, it is much easier to make these images coincide correctly under the cut-off line when they are horizontal, and therefore lacking the height of vertical images. This constraint, which imposes a type of shape with regard to reflectors of the state of the art, is, however, restricting.

Moreover, one can regard the first area of comfort 303 and the second area of comfort 304 of the luminous beam as essentially composed of images from the luminous source reflecting respectively in a third area 203 and in a fourth area 204 of the reflecting surface of the reflector 101. Finally, one can regard the area of breadth 305, of the luminous beam, as being essentially composed of images from the luminous source, reflecting in a fifth area 205, of the reflecting surface of the reflector 101. The complex surface defining the different areas of reflection is the object of calculations known to the professional in the field and designed to achieve the desired luminous beam.

A first problem encountered with this kind of headlight in the current state of the art is that a significant part of the light emitted by the luminous source is lost: effectively, the luminous sources used are an omnidirectional emission, that is to say, diffused into space in all directions. Stemming from the shape of headlights, more particularly from the presence of side panels which limit the height of the reflectors, part of the luminous rays emitted by the source is not made use of in the beam.

A second problem encountered with headlights in the current state of the art is their bulkiness: effectively, as has been seen in the previous remarks, the shape of the complex surface is mathematically defined to create, from the starting point of one single luminous source, the luminous beam in its entirety. The complex surface is therefore formed from one single piece, and thus is voluminous, for it cannot be subdivided into several elements. A third problem encountered with these headlamp devices is that they use up a lot of energy. A fourth problem is that these sources of light are particularly exothermic, and that it is necessary to make provision for various devices for evacuating heat, at the heart of the headlights. Finally, a last problem is associated with the fact that there is only one luminous source: when the latter ceases to function, the entire luminous beam produced by the headlight fails to work.

It is an object of the invention to offer an answer to all the problems which have just been referred to, while at the same time avoiding the constraints which have been mentioned against making the idea a reality. Speaking in a general sense, it is proposed by the invention to incorporate electroluminescent diodes into the various headlight devices already in existence. Several characteristics of electroluminescent diodes are to the advantage of the invention:

In the first place, this type of diode does not give out omnidirectional rays, but its rays shine out in a half-space opposite the substratum which supports its P-N; thus, using a ray propagation which is more easily aimed than that of halogen lamps or discharge lamps, of the current state of the art, the quantity of energy lost is of a lower order of magnitude.

Then, it is the case that these diodes have recently been improved in terms of the intensity of the rays given out; the rays can henceforth reach a luminous flux of about 100 lumens. What is more, the diodes emit rays which have long been in the red area but henceforth are also in the white area. The amount of heat given out by them is limited and a certain number of constraints associated with the dissipation of heat in headlight devices of the current state of the art, disappear. Finally, diodes use up less energy, even when the rays are of equal intensity, than discharge lamps or halogen lamps; they are not very bulky, and their particular shape offers new possibilities for making and putting in position the complex surfaces associated with them.

### SUMMARY OF THE INVENTOR

Thus the invention is essentially concerned with a headlight device, the purpose of which is to give out at least one type of luminous beam, including at least one luminous source and at least one reflecting surface to reflect luminous rays produced by the luminous source, characterized in that the luminous source incorporates at least one component of the electroluminescent type.

The headlight device which accords with the invention can, besides, feature one or several of the following secondary characteristics:

The headlight device emits at least one luminous beam of the type emitted by a dipped mode headlight, or by a sidelight, or by a full-beam headlight, or by a fog light, or which corresponds to one of the AFS functions or to a DRL function. It can emit a luminous beam with a cut-off, notably by suitable parametrizing of the reflecting surfaces associated with the luminous source or sources.

Each component of the electroluminescent diode type, the luminous ray produced by which is a localised ray in a half-space, is oriented in such a manner that at least one part of its ray propagation reaches, on the reflecting surface, one specific area of reflection which is dedicated to it, each specific area being more especially intended to contribute in a particular manner to the production of the luminous beam.

The different specific areas of reflection are divided into sections.

The particular contribution either refers to the range of the light or to the breadth of the light, or to the aspect of comfort.

Each electroluminescent diode of the headlight device is oriented so that the entirety of its ray propagation reaches the specific area of reflection which is dedicated to it.

At least two electroluminescent diodes are used for the range contribution.

The number of electroluminescent diodes is, for example, understood to be between 2 and 20, or between 4 and 14 (for the contribution of range and for all other contributions)

At least one specific area of reflection intended to make the range contribution is a non-horizontal area of the reflecting surface, which is a characteristic totally specific to the invention, and which is not found in more conventional luminous sources.

The luminous source is completed by a ray-propagating element of a halogen lamp type or of a xenon lamp type (also called a discharge lamp or an HID lamp in English) to generate a given luminous beam. One has, then, in this version, a thoroughly innovative “hybrid” lighting system.

The ray-propagating element of a halogen lamp type or of a xenon lamp type gives out rays onto a specific area of reflection which is dedicated to it, the said area having a preferred use of range contribution.

The switching on of at least one element of the electroluminescent diode type can be controlled independently of the switching on of the other elements of the luminous source.

According to a first version, the different electroluminescent diodes which make up the luminous source are in close proximity to each other, in such a configuration as to allow all the diodes together to be assimilated into one single conventional luminous source such as a halogen lamp. Thus, in this case, one is able to group the diodes in a “barrel” or “cylinder” formation, that is to say in a manner such that they are approximately side by side on a revolving support such as a cylinder.

In accordance with a second version, each element of the electroluminescent diode type is separate from the others, and is notably set in a section of the reflecting surface which is dedicated to it, the said section comprising one of the specific areas of reflection, the different sections being set up in a side by side or in a separate manner. In this case one then has as many luminous sources as one has diodes, even if it actually is the totality of the diodes which generates a given beam of light. Thus the mirrors can be formed into a matrix of mirrors. All the mirrors can be adjacent to or separate from each other. They can be mechanically dependent on each other or able to be made so; they can make one unit or otherwise. One has, then, mirror/diode modules which may be assembled in a flexible way in relation to one another, this being of great interest from a viewpoint of the design of the headlight taken as a whole.

One can have both versions in one by including in the same headlight, at the same time, diodes separated from one another and diodes grouped together, not unlike a single conventional light source.

Another object of the invention is a motor vehicle fitted with at least one headlight device, which has at least one of the characteristics which have just been detailed. The invention and its different applications will be better understood when the description which follows is read, and when the drawings which go with it are examined. The latter are shown in the nature of explanation and in no way limit the invention.

### BRIEF DESCRIPTION OF THE DRAWINGS

FIG. 1, which has already been described, shows a schematic representation of a headlight device of the current state of the art.

FIG. 2, which has also been already described, shows a schematic representation of a cut-out, used in the current state of the art, of the reflecting surface of a reflector;

FIG. 3, which has also been already described, shows a schematic representation of the different zones making up a luminous beam;

FIG. 4 is a first example of the making of a reflector used in the headlight device in accordance with the invention;

FIG. 5 is a second example of the making of a reflector used in the headlight device in accordance with the invention;

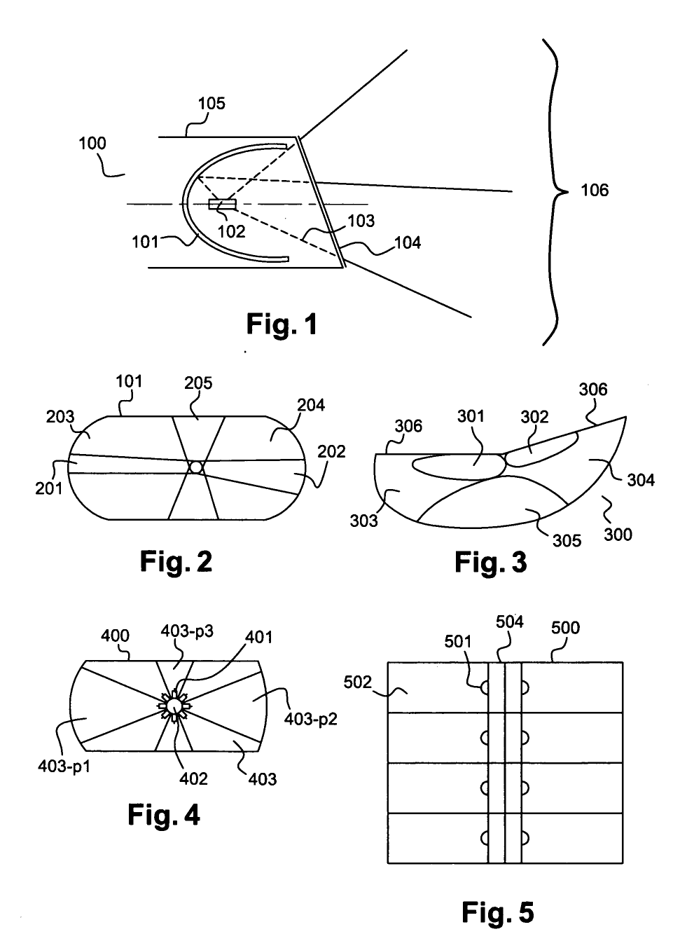

### DESCRIPTION OF THE PREFERRED EMBODIMENTS

FIG. 4 is a head-on view of a reflector 400, intended to be used in a headlamp in accordance with the invention, the general shape of which is very similar to that of headlights of the current state of methods. However, the luminous source is made up of a number of electroluminescent diodes 401, eight in the example shown, which are arranged in a star formation around a central position 402 of the reflector 400. The eight diodes 400 are regularly spaced around the central part 402.

In the example shown, and, considered more generally, in an advantageous way in the invention, each diode in the make-up of a luminous beam is associated in a bijective manner with a particular area of the reflecting surface used to achieve the desired luminous beam. Thus, in FIG. 4, each of the eight diodes is dedicated to a specific area 403, which is allocated to it, of the reflecting surface, the different areas being symbolically demarcated by an unbroken line.

The use of diodes 401, the ray propagation of which is certainly less intense than that of sources of light used in the current state of the art, implies on the one hand the multiplicity of these diodes for making a headlight device which produces luminous beams identical to those of the current state of the art, and on the other hand, an increase in the surface area specifically dedicated to areas of high intensity of the luminous beam. Thus, to achieve a luminous beam of the type shown in FIG. 3, it is necessary to multiply the areas dedicated to the diodes which most particularly contribute to the range zones of the luminous beam. In the example considered, three specific areas are set aside, respectively 403-p1, 403-p2 and 403-p3, which are therefore associated with three distinct diodes, to produce images from each diode which will contribute to the intensity of the range zones. In FIG. 4 it is noted that although, by way of example, two horizontal areas of reflection have been kept, 403-p1 and 403-p2, which contribute to the intensity of the range zones, area 403-p3, which also contributes to the intensity of the range zones, is not horizontal area of reflection. Moreover, among the areas left over, there have still been set aside areas of reflection contributing to comfort zones and breadth zones. Each area of reflection is made in the form of a complex surface for which the calculations are carried out in such a way that the area contributes in an appropriate manner to the production of the luminous beam.

Another possible example of the set-up of the electroluminescent diodes 400 is a set-up referred to as “barrel-like”. In this set-up, a group of electroluminescent diodes is still set up around a central part 402, but in as squeezed together a manner as possible, such that the total luminous flux produced should be comparable to that of a halogen lamp or a xenon lamp usually employed, notably with respect to the omnidirectional nature of the luminous flux produced.

One of the advantages of the set-ups in accordance with the invention is that, from the fact that the shape of the surface emitting light of the diodes used henceforth is square, the areas of reflection set aside for the range zones of the luminous beam are not necessarily the horizontal areas, that is to say, the areas set up in close proximity to a horizontal and central plane of the headlight device. This absence of constraint leaves one a great diversity of choice in the distribution, on the reflecting surface 400, of the roles or the various areas of reflection. To be sure, the emitting surface of the diodes may possibly be other than strictly square, it may have more varied geometric forms (rectangle, triangle . . . ), the specific feature of it being that it is generally a substantially plane surface.

Another advantage is that it is possible physically to put into sections, to separate, the different areas of reflection. In this case, the headlight device, in accordance with the invention, is no longer necessarily cast in one piece, but it is made up of a group of sections which can be distributed in various parts of the front surface, for example, of the vehicle. Each section comprises at least one diode and one specific surface of reflection. Thus, for example, one can set up on the front of a vehicle, a group of diodes which are not necessarily close neighbours, but which, associated with appropriate reflecting surfaces, contribute to the production of the same luminous beam. In other examples, then different sections can, however, be mutually adjacent, so as to give the impression of a headlight device cast in one piece.

Thus one can set up the diodes in a different manner from that of the arrangement which approximates to the current state of the art; FIG. 5 thus shows a reflector 500 where a multiplicity of diodes 501 is set up solely in accordance with a central, vertical axis 504 of the reflector, the different reflecting areas 502 being set up if need be in a sectionalised manner, on each side of the vertical axis 504.

Another advantage of devices in accordance with the invention is that, should a diode break down, this does not cause the total headlight device which is associated with it to stop; effectively, even if the luminous beam is perceptibly modified, the other diodes present in the headlight device ensure that adequate temporary lighting is provided.

In order to reduce the consumption required for the correct functioning of the headlight to which they belong, the diodes are oriented in such a way that the luminous rays they emit in a cone of ray propagation, which belongs to a half-space, reach, in their totality, or thereabouts, a specific area of the reflecting surface of the reflector 400 with which they are associated.

Another advantage of the invention is that the switching on of each diode can be done independently. Thus, if one achieves a first luminous beam, when a group of diodes is giving out rays, the malfunction of one or several of the diodes belonging to this group allows a second luminous beam, different from the first to be obtained.

The headlight device in accordance with the invention can also be supplemented by luminous sources of the halogen-lamp type, or of the discharge-lamp type, also referred to as a xenon-lamp. This supplementary facility may prove of great interest to back up the intensity of the areas of range. The invention therefore also covers hybrid headlights, the luminous source of which is an association between one or several electroluminescent diodes and a halogen lamp or discharge lamp. The halogen lamp or the discharge lamp is then advantageously set aside for the areas of range and the diodes make their contribution to, or are set aside for, the areas of comfort or of breadth of a luminous beam.

What is claimed is:

1- Headlight device, the intention of which is to emit at least one type of luminous beam, comprising at least one luminous source and at least one reflecting surface, to reflect luminous rays produced by the luminous source, wherein the luminous source or at least one of the luminous sources comprises at least one element of the electroluminescent diode type.

2- Headlight device in accordance with claim 1, which emits at least one luminous beam of the same type as those emitted by a dipped headlight, or by a sidelight or by a main-beam headlight, or by a fog light, or corresponding to one of the functions known as AFS, or to a DRL function.

3- Headlight device according to claim 1, wherein each element of the electroluminescent diode type is oriented in such a way that at least one part of its ray propagation reaches, on the reflecting surface, a specific area of reflection which is dedicated to it, each specific area being more specially intended to fulfil a particular contribution in the production of the luminous beam.

4- Headlight device in accordance with claim 3, wherein the different specific areas of reflection are sectionalized.

5- Headlight device according to claim 3, wherein the particular contribution is either a contribution of range, or a contribution of breadth, or a contribution of comfort.

6- Headlight device according to claim 3, wherein each electroluminescent diode, of the headlight device is oriented so that the totality of its ray propagation reaches the specific area of reflection which is dedicated to it.

7- Headlight device according to claim 5, wherein at least two electroluminescent diodes are used for the contribution of range, the number of electroluminescent diodes being understood to be, for example, between 2 and 20, or between 4 and 14.

8- Headlight device according to claim 3, wherein at least one specific area of reflection intended for a contribution of range, is a non-horizontal area of the reflecting surface.

9- Headlight device according to claim 1, wherein the luminous source or at least one of the luminous sources is supplemented by an element giving out rays of the halogen-lamp type or of the discharge-lamp (xenon-lamp) type.

10- Headlight device in accordance with claim 9, wherein the element giving out rays of the halogen-lamp type or of the xenon-lamp type radiates onto a specific area of reflection which is dedicated to it, the said area being preferably used for a contribution of range.

11- Headlight device according to claim 1, wherein the switching on of at least one element of the electroluminescent diode type can be controlled independently of the switching on of the other elements of the luminous source.

12- Headlight device according to claim 1, wherein the different electroluminescent diodes are grouped together, for example in a cylinder shaped arrangement, or are separate from each other.

13- Device according to claim 1, wherein the diodes are associated with reflecting surfaces composed of matrices of mirrors.

14- Headlight device in accordance with claim 4, wherein each element of the electroluminescent diode type is set up in a section of the reflecting surface which is dedicated to it, the said section comprising one of the specific areas of reflection, the different sections being set up in an adjacent or in a separate manner.

15- Motor vehicle fitted with a headlight device in accordance with claim 1.
